(19) United States
(12) Patent Application Publication
(10) Pub. No.: US 2008/0215484 A1
(43) Pub. Date: Sep. 4, 2008

(54) ENHANCED TRANSFER FRAMEWORK FOR SOURCE OR PROCESS VERIFIED PRODUCTS

(75) Inventor: Courtney A. OLDHAM, Bryan, TX (US)

Correspondence Address: FISH & RICHARDSON P.C., P.O. BOX 1022, MINNEAPOLIS, MN, 55440-1022, US

(73) Assignee: AGINFOLINK HOLDINGS, INC. A BVI CORPORATION, TORTOLA (VG)

(21) Appl. No.: 12/031,166

(22) Filed: Feb. 14, 2008

Related U.S. Application Data
(63) Continuation of application No. 09/492,961, filed on Jan. 28, 2000, now abandoned.

(51) Int. Cl. G06Q 30/00

(52) U.S. Cl. 705/39

(57) ABSTRACT

An enhanced transfer framework for source or process verified products, in which, from disparate selling entities, event data is received certifying that animals separately processed by the disparate entities each satisfy requirements associated with source or process verified animal products, and the animals are aggregated for sale as a group of certified source or process verified animals. As the group, the sale of the certified source or process verified animals is effected to a purchasing entity, the event data that identifies the disparate selling entities is filtered out, and the filtered event data is transferred to the purchasing entity.

### CROSS-REFERENCE TO RELATED APPLICATIONS

This application is a continuation of U.S. patent application Ser. No. 09/492,961, filed Jan. 28, 2000, which is incorporated herein by reference.

### BACKGROUND

### Field of Invention and Description of Related Art

This invention relates to a method and system for conducting a cattle auction with an emphasis on quality assurance source verification and performance tracking.

Traditionally in the beef industry, sellers or producers with less than one hundred (100) head of cattle have another source of primary income. Often, because cattle ranching is not their main focus, these producers or sellers have one avenue for marketing cattle-the auction barn.

In some small rural communities, the auction barn plays an extremely important economic, social, and cultural role. However, in recent years, it has become doubtful that the auction market will maintain its historic level of vitality. In the beef industry, there is a trend toward the formation of alliances to produce value-added beef that can be sold as branded products and command higher retail values. These systems mandate that beef products have to be “source or process verified,” meaning that a record of where the animal originated and its life cycle have to be documented.

This has been an obstacle for the traditional auction barn because the source of their cattle has been considered confidential information. If a buyer was able to determine the origin of the cattle, he could bypass the auction barn and go directly to the primary producer. In addition, there has been no information system that could track the origin and movements of cattle throughout the production chain.

It is not likely that a large cattle buyer will have the time or resources to travel across the country to every small producer and buy a few cattle here and there. A buyer generally has to deal in volume so it makes economic sense for the buyer to come directly to the auction barn and purchase cattle at one central location. The economic driver in today's beef market is to make sure the auction barn can provide the type of value-added cattle needed in the new source or process verified systems.

There is a need, for both economic and quality assurance reasons, for an efficient and cost-effective method for identifying and tracking livestock, and for the monitoring of the processing of those livestock. Throughout the livestock production and processing cycle, there is a need for more detailed information so that producers, stockmen, feedlots, packers, distributors and retailers can make informed decisions about factors and variables such as genetics, herd management, purchasing, feed strategies, and ship dates. Producers who improve their animal performance can realize greater returns with performance-based compensation when accurate information about the history and the value of each animal is easily available.

There is also a growing concern about quality assurance in the livestock processing cycle; and there is an opportunity for producers and processors who can establish that quality assurance to improve their compensation. Effective quality assurance programs such as HACCP, or Hazards Analysis and Critical Control Points, programs require accurate and timely information about the history of each animal.

The Beef Industry

The beef industry is a good example of the livestock industry. Traditionally, there are four segments to the U.S. beef industry: the cow/calf producer, the stockman, the feedlot, and the packer.

The cow/calf producer is the most significant figure in the auction barn process. The cow/calf producer is generally the entity in the production/processing cycle that is most likely to sell cattle at the auction barn. The cow/calf producer has a herd of mother cows that are used to produce calves. The cows are bred to bulls so that, ideally, each cow has a new calf each year. The calf crop that is produced each year is used primarily for meat production, with some calves retained as replacements for the herd. The calves are usually weaned from their mothers at between six and eight months of age. The traditional producer will sell his animals once they are weaned. Typically, the main objectives of the producer are to have a calf from each cow each year; to have healthy, vigorous calves with the highest weaning weights at the lowest cost; and to produce the best meat, by factors such as tenderness and taste, at the lowest cost.

In order to support these objectives, the producer is interested in efficient systems for identifying and tracking individual animals as they rotate through the producer's pastures; identifying which animals have a good calving history; monitoring the performance of various pastures; recording calf birth date and birth weight statistics and tracking the genetic history of each animal; evaluating the performance of calves from particular cows or bulls; recording the weaning date and weaning weight of each animal; and recording treatments, vaccinations, and other significant or events that have occurred in the animal's life.

Usually downstream from the auction barn process, the stockman receives the weaned calves when they weigh approximately 500 pounds, and feeds them for four to six months until they weigh 700 to 800 pounds. The stockman's typical objective is to add weight as fast as possible, while keeping the animals healthy. In order to support these objectives, the stockman is interested in collecting and using information such as identifying and tracking individual animals as they rotate through the stockman's pastures; recording beginning, ending, and periodic weight measurements and treatments; and recording vaccinations and other significant events that have occurred in the animal's life in order to track the success of treatments as well as to eliminate duplicate treatments.

Downstream from the stockman phase and further downstream from the auction barn process, the animals are typically sent to a feedlot where they are fed a high-energy diet for about 120 days. At the feedlot, the cattle are in a finishing stage, where the main objective is to add pounds quickly while keeping the animals healthy. The cattle will be finished when they reach a weight of approximately 1,100 to 1,200 pounds. The feedlot is interested in animal weight gain, animal health, the effectiveness of various feed ration formulations, required waiting periods on shipping animals after drug treatments, and animal origin and history.

The slaughter facility or packer typically slaughters the animal and then chills, ages and cuts the carcass into the various cuts of meat and packs those cuts for shipment to distributors and retailers. The packer also provides grade and yield ratings for the carcass. Important quality factors include the live animal weight, the carcass weight, a chilled weight; and the yield, grade, and quality of the carcass and carcass defects. The information collected by the packer is important to all of the upstream participants, because it allows them to adjust their management practices based on the actual quality and economic result for each animal. The upstream data is important to the packer because it permits the packer to select animals that produce the results desired by his customers.

Typically, each of these four segments, the cow/calf producer, the stockman, the feedlot, and the packer, have attempted to optimize their own operations, and there has been relatively little emphasis on cooperative optimization efforts. There is a growing recognition across these industry segments, however, that for both quality assurance reasons and for the improvement of the industry in general, it is desirable to attempt improved data collection and data management. An object of the present invention is to provide that improved data collection and data management.

Variability and Quality Control

There is variability in individual animal production efficiency and in individual carcass quality characteristics such as weight, frame size, muscling, fat content, marbling, and feed efficiency. This variation is due to a combination of genetic factors and environmental factors such as health and drug treatments, nutrition, and growth history. Many of the genetic and environmental factors can be controlled or managed to improve both quality and economic return on investment if accurate historical information were available throughout the production cycle.

The livestock industry has recognized that certain livestock species and breeds outperform other species during production and processing. The prior art has used data collection systems and statistical analysis of data related to livestock breeds in order to identify higher performance breeds. There is a need to extend this data collection so that individual producers can make informed decisions about individual breeding animals in order to further improve their herds.

Electronic Identification

Although it is possible to use manual identification methods for livestock and to employ manual data entry methods, it is desirable to automate the identification and data entry in order to reduce expense and to improve accuracy of the data. These devices typically produce either a unique alphanumeric code or a unique decimal code.

Electronic identification devices and systems have provided a good method for providing identification of livestock. Typically, electronic identification systems utilize a passive electronic identification device that is induced to transmit its identification signal by an externally radiating source. These passive electronic identification devices may be a transponder carried with the individual animal on a collar as illustrated and described in Carroll U.S. Pat. No. 4,475,481, issued Oct. 9, 1984, entitled “Identification System” and in Kuzara U.S. Pat. No. 4,463,353, issued Jul. 31, 1984, entitled “Animal Feeding and Monitoring System”; in an ear tag such as those commercially available from Destron/Fearing, Inc., Allflex USA, Inc. and Avid Marketing, Inc.; in a transponder implanted in the animal as illustrated and described in Pollack U.S. Pat. No. 4,854,328, issued Aug. 8, 1989, entitled “Animal Monitoring Telltale and Information System” and in Hanton U.S. Pat. No. 4,262,632, issued Apr. 21, 1981, entitled “Electronic Livestock Identification System”; or in a bolus such as illustrated and described in U.S. Pat. No. 4,262,632, issued Apr. 12, 1981, entitled “Electronic livestock identification system” by John P. Hanton and Harley A. Leach.

Although electronic identification through radio frequency identification (RFID) tags or barcodes are used in some phases of the livestock production cycle, there is a need to provide a means for individual animal identification throughout the production cycle and to minimize the difficulty of data entry throughout the industry.

RFID Readers

Several RFID readers are commercially available, typically from the transponder suppliers, including models from Destron/Fearing, Inc., Allflex USA, Inc. and Avid Marketing, Inc.

The prior art includes RFID readers that can distinguish multiple types of RFID transponders as illustrated and described in U.S. Pat. No. 5,235,326, issued Aug. 10, 1993, “Multi-mode identification system” to Michael L. Beigel, Nathaniel Polish, and Robert E. Malm.

Databases and Management Systems

At different stages of the production cycle, there are different databases, which exist for different business purposes. The producer will typically maintain his own database, a stockman will have an inventory system, a feedlot will have a management database, and a packer will have its own inventory and management system. There is also a trend toward larger marketing alliance or national databases that include some data from each of these industry segments.

U.S. Pat. No. 5,322,034, which issued Jun. 21, 1994 to Richard L. Willham, for a “Livestock record system” describes a method for storing the individual animal's identification and performance data on a programmable electronic identification and data storage module carried with the animal. An object of the present invention is to provide a low-cost per animal system for obtaining and maintaining source verification and performance databases that are independent of the animal.

U.S. Pat. No. 5,315,505 issued to William C. Pratt on May 24, 1994 for a “Method and system for providing animal health histories and tracking inventory of drugs” describes a method and system for providing improved drug treatment to selected animals in a retained group. A computer system is used to provide an operator with the health and drug treatment history of an animal. With this information and a diagnosis of the animal's health condition, a drug treatment is chosen. The diagnosis and treatment are entered into the computer system to update the animal's health and treatment history. An object of the present invention is to provide complete source verification and performance databases for all key livestock events.

U.S. Pat. No. 5,673,647 for a “Cattle management method and system”, issued on Oct. 7, 1997 to William C. Pratt, describes an automated method and system for providing individual animal electronic identification, measurement and value based management of cattle in a large cattle feedlot. That method includes individual animal identification, a computer system, and multiple measurements coupled with a cattle handling and sorting system. An object of the Pratt patent was to build a feedlot data base to more accurately identify and measure characteristics such as weight, so that subsequent animals could be produced and fed for more effective value-based selection and management of the animals. In particular, that database related to calculations for economic management of feeding and shipping to permit optimum weight gains and feedlot ship dates. Whereas the feedlot patent disclosed identifying a particular animal on arrival at the feedlot, an object of the present invention is to track individual animals from the auction barn throughout the production cycle and to maintain performance and source verification data in the least disruptive manner to existing databases and management systems.

### DESCRIPTION OF FIGURES

These and other features, aspects, and advantages of the present invention will become better understood with regard to the following description, appended claims, and accompanying drawings where:

FIG. 1 is an illustration of the items sent to a livestock producer such that a livestock producer may participate in this unique type of auction.

FIG. 2 is an illustration of the processing guidelines according to which a livestock producer's cattle must be processed such that the livestock producer's cattle may participate in the auction.

FIG. 3 is an illustration of a sales certification form pursuant to which a livestock producer certifies that his/her livestock have been processed according to guidelines.

FIG. 4A is an illustration of the front side of a data card which is to be completed by the livestock producer, such that certain important identifying and health information is documented for each animal.

FIG. 4B is an illustration of the back side of a data card which is to be completed by the livestock producer, such that certain important identifying and health information is documented for each animal.

FIG. 5 is an illustration of a code card that is used to assist the livestock producer in completing the data card.

FIG. 6A and 6B are a flow diagram of the preferred methodology for conducting the auction.

FIG. 7 is an illustration of the system used for entering the data from the data cards into the BEEFLINK data collection software database.

FIG. 8 is an illustration of a bar code used for automated entry of data into the BEEFLINK data collection software database.

FIG. 9 is an illustration of the preferred embodiment for the system for checking the animal in to the auction.

### SUMMARY OF THE INVENTION

In accordance with the present invention, a method and system for conducting a cattle auction is described. An objective of the present invention is to provide a unique value-added beef supply system through a systemized approach to documenting, among other things, the individual animal's identity, its vaccinations, treatments, and nutrition. According to the present invention, each head of cattle is processed according to guidelines which must be verified and documented by the seller prior to sale of the cattle. The auction process in present invention is improved to allow for premium services to auction buyers so that buyers may have automatic transfer of value-added information from the auction barn to buyers. In addition, the cattle data is collected from the seller prior to the sale. That information is available to others involved in a particular head of cattle's production/processing cycle such that quality assurance source verification and performance tracking may be implemented. Through the current invention, the history of an animal is available throughout the production cycle, and both source verification and specific performance information are accessible without unnecessary duplication of data. The auction process is improved to allow for premium services to auction sellers so that sellers may have easy access to downstream animal information. In many cases animals from the auction barn will go to the feedyard. At the feedyard, the manager can review the history of the animals coming from this special sale and determine the incoming animal protocol based upon real data. This is a tremendous cost saving to the feedyard, as most animals without a verified history are re-vaccinated. The feedyard has to vaccinate because they do not know if the animals has had received the vaccinations, and they can't afford sick animals. The re-vaccination that takes place is very costly and this system offers a solution. In addition, the manager can see that the animal has been weaned properly based upon the history, he knows that these animals have the best chance of performing well and staying healthy.

The present invention provides an efficient and cost-effective system and method of livestock data collection and data management that will provide quality assurance, HACCP compliance, and source verification data for individual animals throughout the production cycle.

The present invention provides a marketing opportunity for the seller, the auction barn, the buyer and the beef industry as a whole. The seller benefits in that the seller has the opportunity to sell his cattle according to quality assurance guidelines and obtain an economic payoff. Sellers also obtain an economic payoff in that they are able to reach a market which they might not otherwise reach. Small producers might only have one or two animals to sell in a week. If the seller had placed an ad in the paper for a quantity of two (2) four hundred (400) pound calves it might be difficult for the seller to get the money that the animals are worth. However, if the seller is able to combine his two (2) calves with a large number of other four hundred (400) pound calves, cattle buyers are interested because now they are able to get the larger volume which is desired to fill up their feedlot pens. This is the first time in auction barn history that a system has been put into place to provide performance data on animals back to a seller. Through the current invention, the seller can see if the animals he or she produces perform well. If the seller does not perform well, the seller knows he or she needs to make a change in the genetics of his or her operation. If the animals do perform well, the seller has the ability to market high quality cattle and has the factual data to prove it.

The packing plant also benefits from the current invention. The data collection can extend to the plant level, although not every packing plant in the United States is equipped with a data collection system or strategy, some do have that capability. If carcass data is collected and sent through the system of the present invention, that information will be routed back to the feedlot and the auction barn. This gives the seller and the feedyard the ultimate “report card” giving them a record of how well the animal graded and yielded at the packing plant. At this time, downstream data is not guaranteed. However, the number of packing plants, feedyards, and other buyers using the software which is a part of the present invention, particularly the BEEFLINK™ Data Collection Software, is growing.

The auction barn benefits in that it receives higher commissions. The auction barn is generally paid a one percent (1%) to three percent (3%) commission on the value of the animals that are sold at the barn. If the sale involves higher quality process-verified cattle that are worth more, the barn's commission will be higher. This type of sale is very unique and provides a customer service that cannot be obtained at any other sale barn.

Another objective of the present invention is to economically benefit the buyer. Statistics show that cattle that have gone through the process-protocol involved with this sale will perform better. They have a greater chance of remaining healthy and eating grass and grain on their own. If animals become ill, the buyer spends a significant amount of money on pharmaceuticals and labor to bring the animal back to health. Therefore, process-verified animals have a greater economic value. The buyer economically benefits as well as saves time in that the methodology of the present invention allows the buyer to purchase large drafts of cattle at once. Cattle are sorted according to size, type and breed in the present invention and may be auctioned in groups as well as individually.

The beef industry also benefits from the present invention. The beef industry is fighting an uphill media battle waged by anti-red meat advocates. The consumer is bombarded with messages about the saturated fat, cholesterol, and food safety issues associated with beef. Many in the beef industry are collectively trying to improve the quality and consistency in the end product. One of the trends to accomplish this goal is the formation of alliances to provide branded beef products to the retail market. The consumer would be provided a special brand of beef, such as “Certified Angus Beef™” rather than a generic product. In order to put a name on a product, the production chain has to be documented and verified such that a consistent and high quality product is produced. The method of the present invention is the first step in documenting the production cycle of animals that originate in a herd of one hundred (100) head or less. It has been easier to document large herds because cattle ranching is their primary focus and the economic drivers in a large operation naturally occur. The ability to tap small producers that account for 85% of the cattle produced in the United States is unique.

Another objective of the present invention is to provide an automated auction barn system. Animal data is collected using a radio frequency identification reader, instead of by key entry. Moreover, electronic databases are maintained in connection with the system which prepare checks for the sellers and invoices for the buyer, thereby reducing the amount of labor required to conduct an auction.

Although the invention is described in the context of beef cattle, it is not so limited. It should be apparent to those skilled in the art that the invention can be modified, without departing from its principles, for other livestock including cattle, swine, sheep, goats, and fowl.

### DETAILED DESCRIPTION OF THE INVENTION

This application is related to application Ser. No. 09/036,564, filed Mar. 9, 1998, entitled “Method and Apparatus for a Livestock Data Collection and Management System”. That application is pending before the Patent and Trademark Office at the time of the filing of this application.

Pre-Auction

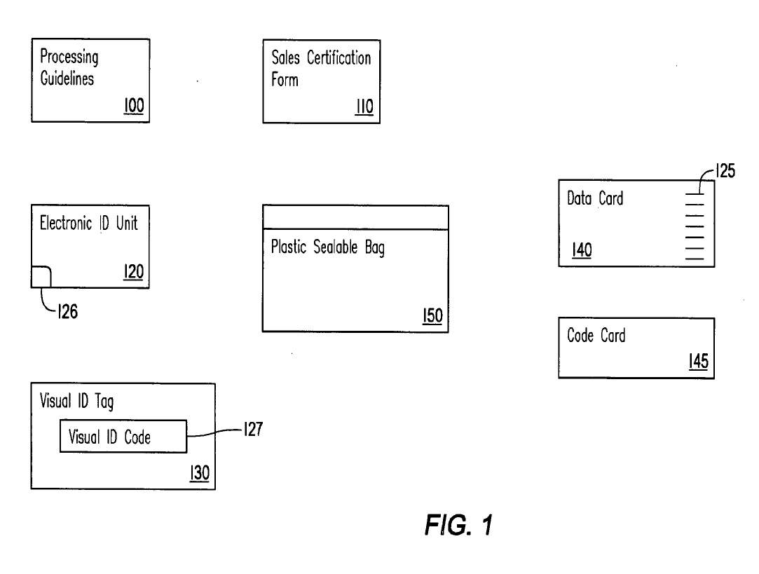

Referring now to FIG. 1, the preferred embodiment for the automated auction barn system, the seller is given certain items prior to the auction. These items include processing guidelines 100, a sales certification form 110 for each animal to be auctioned, an electronic identification unit 120 for each animal to be auctioned and when queried by an radio frequency identification reader the electronic identification unit provides a unique code 126 for the animal, a visual identification tag 130 for each animal containing a visual identification code 127 for that animal, a data card 140 for each animal containing a bar code 125 that uniquely identifies the animal, a code card 145 containing abbreviations for assisting in completing the data card, and a plastic sealable bag 150 for containing the electronic identification unit 120, visual identification tag 130, and data card 140. In alternative embodiments, the data card may be combined with the sales certification form, and this combined form may also include the processing guidelines.

Processing Guidelines

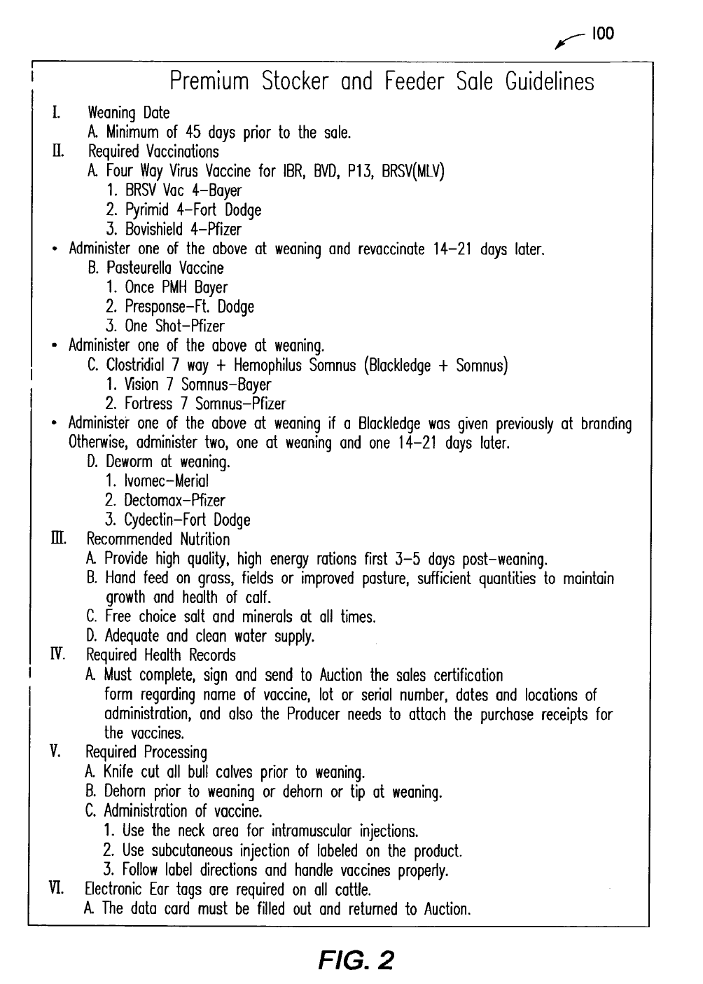

Referring now to FIG. 2, an illustration of guidelines 100 presented to a seller, preferably, the guidelines are contained in a brochure or other printed matter. The guidelines may also be given to the seller orally. Processing guidelines are preferably provided to the seller on the following topics related to the animal: (1) required weaning date; (2) required vaccinations and medication; (3) recommended nutrition; (4) required treatments; (5) required electronic identification; and (6) required health records.

Weaning Date. The weaning guideline provides that the animal must be weaned a minimum of forty-five days prior to the sale of the animal at the auction barn.

Required Vaccinations and Medication. The required vaccinations guidelines include a four-way virus vaccine requirement for IBR, BVD, P13, BRSV (MLV). The following trade names and manufacturers are preferred for the four-way virus vaccine: (1) BRSV VAC 4-BAYER; (2) PYRIMID 4-FORT DODGE; or (2) BOVISHIELD 4-PFIZER. If a vaccine of one of the preferred trade names and manufacturers is used, the four way vaccine should be administered first at weaning, and then again fourteen (14) to twenty-one (21) days later.

Another required vaccination is one for Pasteurella. The seller is required to ensure the administration of a Pasteurella vaccination according to the requirement for a Pasteurella vaccine. The following trade names and manufacturers are preferred, with the Pasteurella vaccination being administered at weaning: (1) ONCE PMH-BAYER; (2) PRESPONSE-FORT DODGE; or (3) ONE SHOT-PFIZER.

The seller is also required to vaccinate for two ailments affecting cattle, blackleg and somnus, according to the blackleg/somnus guideline. Preferably, if a Blackleg was given previously at branding, one of the following should be administered at weaning for Clostridial 7 way+Hemophilus Somnus (Blacklege+Somnus): (1) VISION 7 SOMNUS-BAYER; or (2) FORTRESS 7 SOMNUS-PFIZER. If a Blackleg was not previously given at branding, it is preferred that two administrations—one at weaning and another fourteen (14) to twenty-one (21) days later—of the following be given for the aforementioned Clostridial 7 way+Hemophilus Somnus (Blacklege+Somnus): (1) VISION 7 SOMNUS-BAYER; or (2) FORTRESS 7 SOMNUS-PFIZER. A deworm medication should also be administered once at weaning according to the deworm medication guideline. The preferred trade names and manufacturers are as follows: (1) IVOMEC by MERIAL; (2) DECTOMAX by PFIZER; and (3) CYDECTIN by FORT DODGE.

Required Location of Administration of Vaccinations. Guidelines are established for the location of administration of vaccinations according the administration location guideline. Preferably, the neck area is used for intramuscular injections. The neck is not a valuable meat product so it is an ideal place for an injection. An injection site can bruise and cause the area to be unusable for meat. A subcutaneous injection should be used if labeled on the product. All label directions should be followed and vaccines properly handled.

Recommended Nutrition. The guidelines also contain standards for recommended nutrition according to a recommended nutrition guideline. Preferably, high quality, high energy rations, e.g., hay or grass, are provided the first three (3) to five (5) days after weaning. When hay is first cut is has its highest level of nutrition. As the hay dries, its protein content is reduced. Therefore, freshly cut hay is a good ration for the animal. Different types of hay also have different nutritional values. Animals should be placed on pastures with good quality grasses and if the fields do not have high quality forage, the nutrition from the fields can be supplemented with high quality hay. The cattle should be hand-fed on grass, fields or improved pasture in sufficient quantities to maintain the growth and health of the calf. The cattle should be given their free choice of salt and minerals at all times. In order to fulfill this processing requirement, the seller could put a salt block and a mineral block in the field by the water for the animal's consumption. The animals should also be given an adequate and clean water supply. An adequate water supply means as much as the animal wants to drink. A typical four hundred (400) pound animal will drink approximately four (4) to nine and one-half (9½) gallons a day and a nine hundred (900) pound animal will drink eleven (11) to sixteen (16) gallons a day. The water should be fresh and free of debris.

Required Treatments. The guidelines also include standards for treatments performed on the animals. Preferably, all bull calves are castrated prior to weaning. Moreover, preferably, the calves are dehorned prior to weaning; in the alternative they are dehorned or tipped at weaning. With dehorning, the animal's horn is essentially entirely removed, while tipping only removes a significant portion of the animal's horn.

Required Electronic Identification. The guidelines also provide that electronic identification is required for all animals. Preferably, the electronic identification is in the form of a radio frequency identification (RFID) transponder located on the animal's ear. The animal may also be identified using an RFID transponder on a neck collar, a leg collar, a rumen bolus or implant. Typically, electronic identification transponders are placed through the animal's ear; a rumen bolus is typically placed in the animal's stomach region; a radio frequency identification implant may be placed on any part of the animal's body.

Required Health Records and Sales Certification Form. After the animal has been processed according to guidelines, the seller certifies that the animal has been processed according to the guidelines, swearing this information is true. The seller must also provide required health records, including records on the vaccinations and medication required by the guidelines, when submitting the sales certification form. The sales certification form contains fields for the seller to provide background information, identification information on the animal, information on vaccinations given to the animal, and the seller's signature. Each field may be in the form of a blank, in which case the seller writes in the information. Alternately, the field may be in the form of a box, in which case the seller checks the box. By submitting this form, the seller swears by his signature that the information contained therein is true.

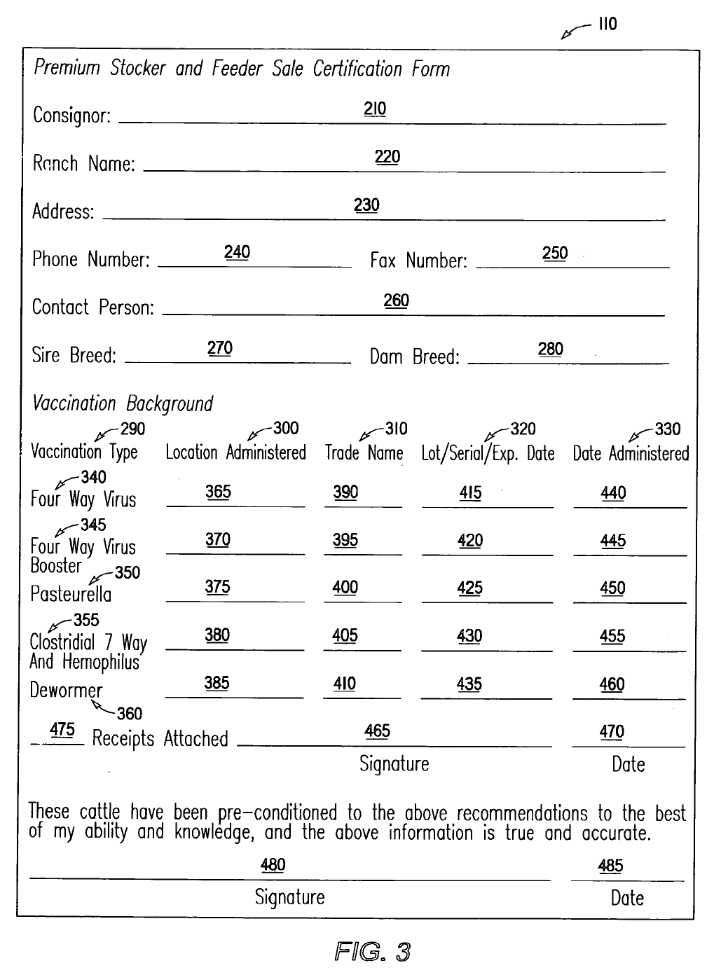

Referring now to FIG. 3, the preferred embodiment for the sales certification form 110, the sales certification form includes fields for providing information such as the seller's name 210, the name of the ranch from which the animal came 220, the seller's address 230, the seller's phone number 240, the seller's fax number 250, a contact person for the seller 260, the animal's sire breed 270 and the animal's dam breed 280.

The seller has been required through the processing guidelines to administer certain vaccinations and a deworm treatment on the animal. The sales certification form 110 also contains fields for providing specific information on the occurrence of the vaccinations and deworm treatment. The sales certification form 110 contains headings for the type of vaccination/treatment administered to the animal 290, the location of administration of the vaccination 300, the trade name of the vaccination 310, the lot, serial number and expiration date of each required vaccination for the animal 320, and the date of administration of each vaccination/treatment 330. As illustrated on the sales certification form 110, the required vaccinations/treatments include a four-way virus vaccination 340, a four-way virus booster vaccination 350, a Pasteurella vaccination 360, a clostridial seven-way and hemophilus somnus vaccination 370 and a deworm treatment 380. For each of these required vaccinations/treatment, the seller is required to provide information on the following: the location of administration of each vaccination/treatment at 390, 400, 410, 420 and 430; the trade name of each required vaccination/treatment 440, 450, 460, 470 and 480; the lot, serial number and expiration date of each required vaccination/treatment 490, 500, 510, 520 and 530; the date of administration of the vaccination/treatment 540, 550, 560, 570 and 580. The seller's signature 590 and the date of the seller's signature 600 show when the form was filled out. The seller is also required to attach the purchase receipts for the vaccines 610. The seller swears the animal was processed according to processing guidelines by a certification to the accuracy of the information by his or her signature 620 and the seller also fills in the date of such certification 630.

Data Card

After the animal has been processed according to guidelines and the seller certifies to same, swearing that it is true, the data card is completed and provided to the auction barn. The seller has obtained a package from the auction barn along with the guidelines, sales certification form, and electronic identification unit. By completing a data card by hand, this system allows sellers to electronically identify and track an individual animal using an electronic identification unit having a unique animal code for each animal.

Referring back to FIG. 1, the seller is given an individual electronic identification unit 120 and a pre-printed, two-sided, 4″×6″ data card 140 which are preferably packaged in a 5″×7″ plastic sealable bag 150. The plastic bags should be opened by the seller one at a time to ensure accuracy since the data card 140 and electronic identification unit 120 are linked with the same animal. Typically, the individual electronic identification unit 120 is an electronic identification transponder. The individual electronic identification unit 120 may also be a rumen bolus, or a radio frequency identification implant that uniquely identifies the animal assigned with its identification code.

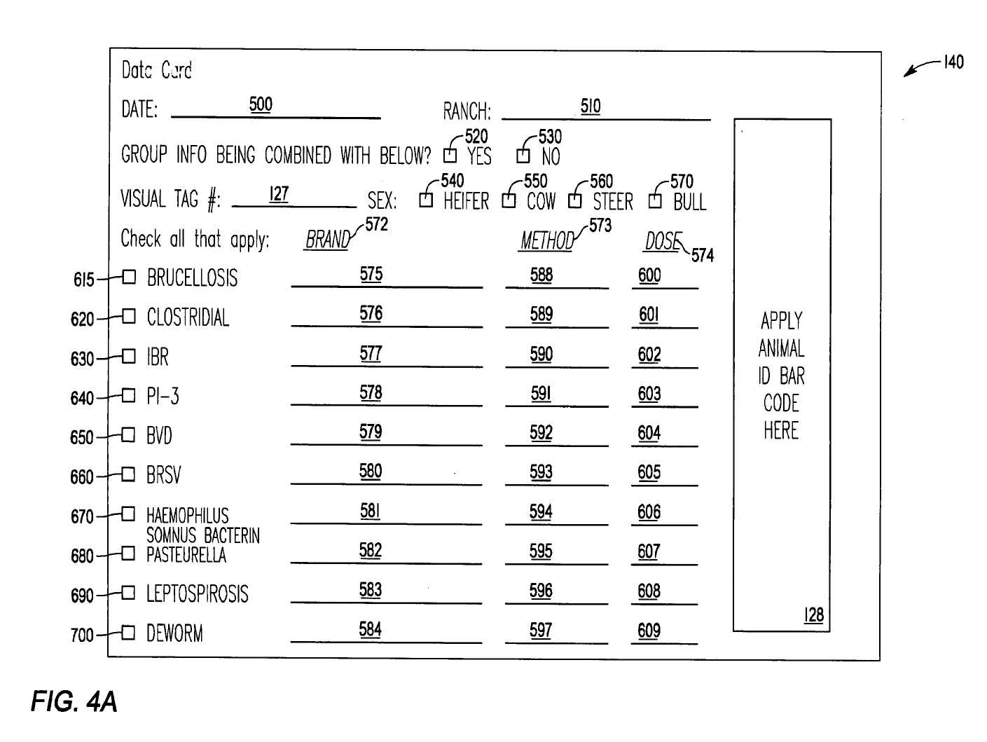

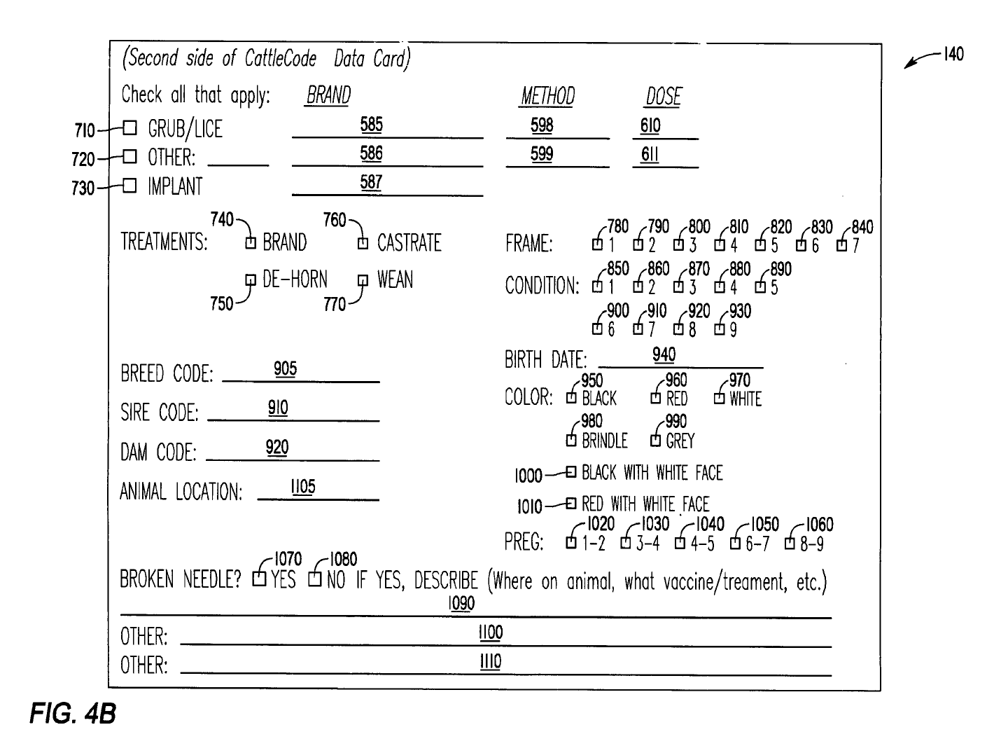

Referring now to FIG. 4A, an illustration of the front side of the data card 140, a bar code label 125 corresponds to the animal's unique animal code. The preprinted data card 140 is two-sided and has fields such that certain specific information may be filled in regarding the animal. Each field may be in the form of a blank, in which case the livestock producer writes in the information. Alternately, the field may be in the form of a box, in which case the livestock producer checks the box. As illustrated in FIG. 4A, the front side of the data card 140 contains a field for the date 500 which is the date the animal is electronically equipped with an individual animal radio frequency identification tag. The data card also has a field for the ranch 510, meaning the ranch from which the animal is currently located. The data card has a field for the animal's visual identification tag number 127 which may be obtained from the items sent to the livestock producer.

The data card further contains group information fields 520 and 530 which allow the livestock producer to check “yes” or “no” when answering the question of whether the particular animal is part of a larger group for which common information is being used. The livestock producer can save time by entering some common group information with respect an entire group. If a set of events are being performed on a group of animals being identified and tagged by the rancher, then the livestock producer can complete a “Group Information Worksheet” which can be submitted along with each data card 140. The data card 140 also asks for the sex of the animal, which can be designated as “heifer” 540, “cow” 550, “steer” 560 or “bull” 570.

Vaccinations and medications are important information and the data card 140 contains fields for certain common specific vaccinations and medications used with respect to livestock, such that the livestock producer can indicate whether the animal is receiving any of the listed vaccinations or medications. The front side of the data card 140 also contains fields so that the livestock producer can insert the brand 572 at fields 575 through 584 (inclusive), the method 573 at fields 588 through 597 (inclusive), and dose at fields 600 through 609 (inclusive) of each of the listed vaccinations/medications. These common vaccinations and medications include: Brucellosis 615; Clostroidal 620; IBR 630; PI-3 640; BVD 650; BRSV 660; Haemophilus somnus bacterin 670; Pasteurella 680; Leptospirosis 690; and Deworm 700.

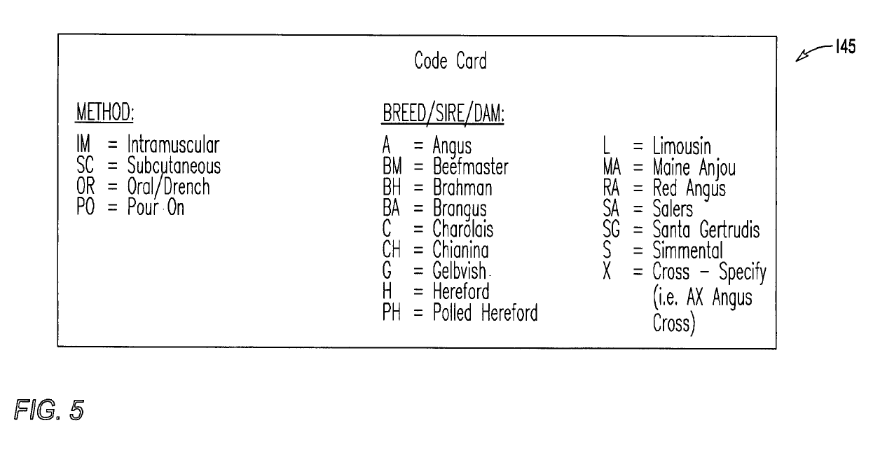

Referring now to FIG. 4B, the back side of data card 140, the data card contains fields for indicating whether the animal has received a Grub/Lice 710 treatment, the brand of the Grub/Lice treatment 585, the method by which such a Grub/Lice treatment was administered 598, and the dose of the Grub/Lice treatment 610. Whether or not other vaccinations or treatments were administered may be indicated at field 720, as well as the brand 586, method 599 and dose 611 of such other vaccination/treatment. The method by which a vaccination or medication was administered may be abbreviated using the abbreviations shown on one of the code cards, e.g., 110 for method. As illustrated in FIG. 5, at least one code card 110 is included with the items which were sent to the rancher. Preferably, there is at least one code card and the card lists abbreviations to be used when completing the data card. As illustrated in FIG. 5, the method by which a vaccination or treatment is administered may be abbreviated. For example, “IM” may be used to designate an intramuscular injection. Also, “SC” may be used to designate subcutaneous. “OR” may be used to designate “oral/drench”. “PO” may be used to designate “pour on”.

Referring back to FIG. 4B, the data card can be used to designate the brand of the implant in the field for implant 587. The animal's treatments may be indicated in the fields for same as brand 740, dehorn 750, castrate 760 and wean 770. The animal's frame may be rated with a rating from 1-7 with each rating having a different field as shown in FIG. 4B as 780, 790, 800, 810, 820, 830, and 840, respectively. Likewise, the animal's condition may be rated with a rating of 1-9, inclusive, as illustrated in FIG. 4B as 850, 860, 870, 880, 890, 900, 910, 920 and 930, respectively. The data card also has fields to fill in information on the breed 905, sire 910 or dam 920 information on the animal using abbreviations printed on the code cards, e.g., 110. Abbreviations may be used in the interest of time efficiency. Referring back to FIG. 5, the code card 110, the following abbreviations and their accompanying definitions may be used for the breed, sire and dam information as set forth in FIG. 5: “A”=“Angus”; “BM”=“Beefmaster”; “BH”=“Brahman”; “BA”=“Brangus”; “C”=“Charolais”; “CH”=“Chianina”; “G”=“Gelbvieh”; “H”=“Hereford”; “PH”=“Polled Hereford”; “L”=“Limousin”; “MA”=“Maine Anjou”; “RA”=“Red Angus”; “SA”=“Salers”; “SG”=“Santa Gertrudis”; “S”=“Simmental”; “*X”=“Cross”, designating a cross-breed and can be used in conjunction with the actual breed designation, such as “AX”=“Cross Angus”.

Referring back to FIG. 4B, the data card 140 also includes a field for the animal location 1105, which is generally a pasture description or a pen number.

Additional fields are indicated on the data card 140 including the animal's birth date 940, the animal's color as black 950, red 960, white 970, brindle 980, grey 990, black with white face 1000, or red with white face 1010. Pregnancy checks performed on the animal may be indicated in the fields of the data card for: pregnancy check at 1-2 months 1020, pregnancy check at 3-4 months 1030, pregnancy check at 4-5 months 1040, pregnancy check at 6-7 months 1050, and a pregnancy check at 8-9 months 1060. The data card 140 also has fields for indicating whether a broken needle has been found on the animal 1070, whether a whether a broken needle has not been found on the animal 1080, and if a broken needle was found, a field for indicating the vaccine or treatment for which the needle was found 1090. Other incidents may be indicated using the “other” fields as illustrated at 1100 and 1110.

The livestock producer can check and/or detail the applicable items listed on the data card while attaching individual animal radio frequency identification tags to the livestock. The livestock producer may also attach a visual identification tag to the animal. Preferably, the visual identification tag contains the same unique code as that on the individual animal radio frequency identification tag. Alternately, the visual identification tag may also contain any other identifying designation for the animal. However, the identifying designation on the visual identification tag must be correlated to the identification code contained on the individual animal radio frequency identification tag so that both codes uniquely identify the same animal. As the livestock producer equips the animals with these units, the livestock producer should complete any information on the data card which is applicable to the animal being electronically identified. In the interest of time efficiency, the livestock producer can specify information that is the same for all animals being tagged on the portion of the envelope which is designated as “common information. If the livestock producer would like to track information that is not listed on the card, the livestock producer may use one of the “other” fields 1100 and 1110 listed at the end on the back of the data card and a “common information” envelope which may be enclosed with the shipment. For example, if the livestock producer would like to record the animal's disposition, the livestock producer could write “Disposition-Gentle” on one of the “Other” fields 1100 and 1110.

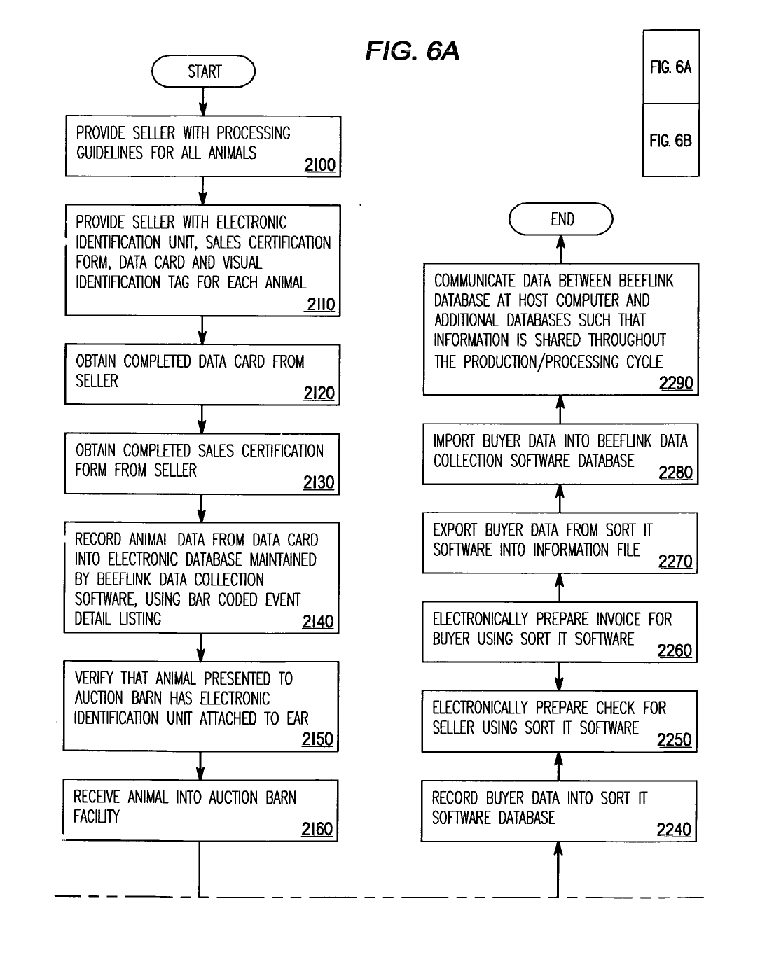

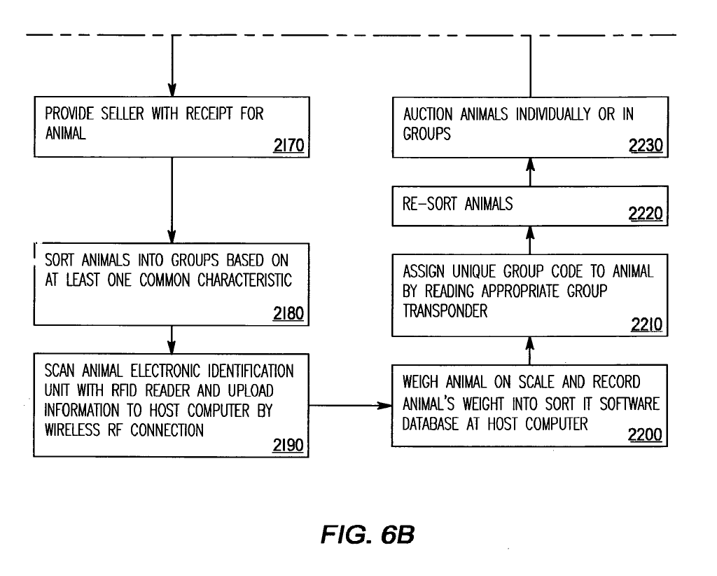

Referring now to FIG. 6, an illustration of the preferred methodology 2000 for the present invention, the seller has been provided with processing guidelines at step 2100; the seller has also been provided with an electronic identification unit, sales certification form, data card and visual identification tag at step 2110. The seller equips the animal with the electronic identification unit and the visual identification tag. After the seller processes each animal according to the processing guidelines that have been provided to the seller, completes a data card for each animal, and sends the data card and sales certification form back to the auction barn. The auction barn obtains the completed data card at step 2120. The auction barn obtains the completed sales certification form at step 2130. Alternatively, the data card and certifcation form may be combined. The information from the data cards is entered into a first electronic database maintained using a host computer for the auction barn facility as in step 2140. Preferably, the first electronic database is maintained using BEEFLINK data collection software. Alternatively, step 2140 entering the animal data into the electronic database may be deferred until later in the process, such as after assigning a group code 2210.

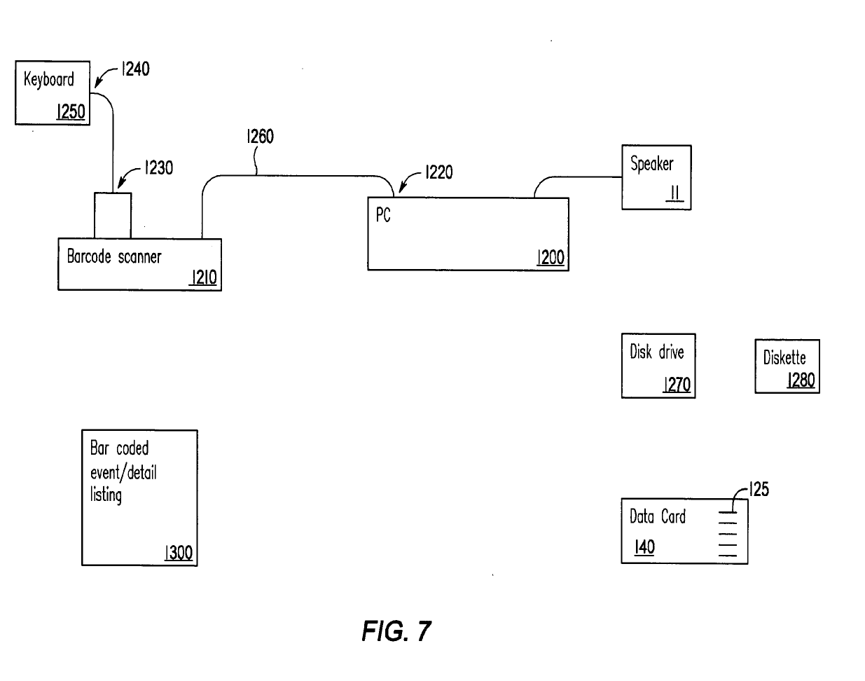

Referring now to FIG. 7, an illustration of the system used for entering the data from the data cards into the first electronic database, the animal's identifying data and other data from the data card will be processed under the livestock producer identification code which is assigned by a processing office. A bar code scanner 1210 and a bar coded event/detail listing 1300 may be used for entering much, if not all, of the information. The bar code scanner 1210 should be installed to the computer 1200 such that the unique animal identification bar code 125 on the data card and the bar coded event/detail listing 1300 can be read by using the following steps: make sure the computer 1200 is powered down; unplug the keyboard 1250 from the keyboard port 1220 of the computer 1200; connect the keyboard connector 1240 to the mating connector 1230 of the bar code scanner 1210; connect the second connector 1260 of the bar code reader to the keyboard port 1220 of the computer 1200; turn the computer 1200 on; enter a word processing program or other program that has a screen to view the key entered information; check to determine whether there is a problem with receiving data from the scanner and if there is a problem, check the keyboard 1250 to scanner 1210 and scanner 1210 to computer 1200 connections for proper connection.

Data Entry to BEEFLINK™ Data Collection Software

As noted in the preceding paragraph, BEEFLINK™ data collection software is the preferred integrated electronic database for the current invention. The BEEFLINK™ data collection software system is used for beef cattle and is easily adaptable to other livestock species, with the major change being the definition of industry-specific default events.

BEEFLINK™ data collection software is comprised of hardware and software to permit the user to scan ear tags, implants, collars, or boli with radio frequency identification scan readers; to scan bar codes; to enter new animals; to look up information on existing animals; to input new events; and to run queries on the work done. One objective of the software is to display pertinent data on each animal and add new events to the record in the least intrusive manner. The new animal records and events recorded are uploaded and incorporated into a larger database. Communication with the larger database allows the user to receive downstream animal performance data at his own computer.

The minimum components necessary to operate the system are as follows: a host computer which is an IBM-compatible desktop or laptop computer with WINDOWS™95 (or higher) operating system; 75 MHz 486 processor; 16 MB RAM; one serial port; 1 GB hard drive; 28.8 Kbps modem; 3.5″ floppy disk drive; external power supply; MS-ACCESS™97 database software; BEEFLINK™ data collection software; a completed data card for each animal to be entered into the system; a bar code scanner for entering data into the database maintained by BEEFLINK data collection software; a bar coded event/detail listing for scanner entry of data from the data card into the database maintained by BEEFLINK data collection software; RFID electronic identification units for each animal to be entered into the system.

The preferred components of the system are as follows: a host computer which is an IBM-compatible desktop or laptop computer with Windows™95 (or higher) operating system; 166 MHz Pentium processor or higher; 32 MB RAM; one serial port; 2 GB hard drive or higher; 28.8 Kbps modem; 3.5″ Floppy disk drive; CD-ROM drive; Sound card and driver; external speakers; external power supply with DC connection; PC-ANYWHERE™ remote access software; MS-ACCESS™97 database software; BEEFLINK™ data collection software; a completed data card for each animal to be entered into the system; a bar code scanner for entering data into the database maintained by BEEFLINK data collection software; a bar coded event/detail listing for scanner entry of data from the data card into the database maintained by BEEFLINK data collection software; RFID transponders on each animal.

Still referring to FIG. 7, which is a schematic of one embodiment of the integrated electronic database or system, the BEEFLINK™ data collection software runs on the host computer 1200 which may be either laptop or desktop computer. FIG. 7 illustrates a simple embodiment of the bar code scanner 1210 linked by connection 1260 to a host computer 1200. In this case, animal identification would be obtained from bar code 125 on the data card 140. The speaker 11 provides a feedback means to confirm the receipt of the animal identification from the bar code and animal data as scanned from the event/detail listing into the database at the host computer 1200. A disk drive 1270 is connected to the host computer 1200. A diskette 1280 which includes a file for defining the bar codes listed on the event/detail listing 1300.

Double-clicking the icon of the BEEFLINK data collection software on the Windows 95 Desktop display starts the BEEFLINK™ data collection software program. When the Company ID, the User ID, and the Password are entered on the Authorization Screen display, the program can be accessed.

Once authorization has been verified, a Command Center display permits graphical user interface navigation to the Data Collection Center, the Communications Center, the Report Center, or Housekeeping. The Housekeeping functions include Setup User Security, Password setup, and Program Defaults configuration such as units of measure, choice of language, and date formats.

The Data Collection Center permits equipment setup so that the BEEFLINK data collection software can receive data from multiple devices or output data to multiple devices.

Although the user may watch the results of his scans on the screen, it is not necessary to see the screen while processing animals. A feedback acknowledgement in the form of a light or sound may be sent to the user to indicate that the scans have gone through correctly. This feedback can be directed through a serial port to an external device. The feedback could also be generated through another device such as a data concentrator unit. Typically the user will get a positive feedback signal in the form of an audio acknowledgement when he reads an animal that exists. The user will also get the audio acknowledgement when he scans an event/detail.

When a new animal is scanned, the system cannot recognize the bar code identifying the animal 125 scanned so the user is signaled to re-scan the animal to verify that it was read. Upon receiving the verified scan, the system enters the new animal into the database. The new animal has only one piece of data so far—its unique code as represented by the bar code label. Other data is entered preferably with the bar coded event/detail listing.

If all of the animals being worked are new to the system, some defaults will probably be entered into the system. For instance, if all animals have the same estimated birth date, the date can be set as a default and added automatically to the birth date field of each new animal scanned. The same default function could be used for origin, location, or group.

If, however, the animals have varying birth dates or birth years, the available birth dates can be assigned to bar codes which previously had no designation. The user can use BIRTHDATE as the event and the date as the detail. As each animal is scanned, the correct birth date tag is scanned and assigned to the animal.

Steps for entering data from the data card to BEEFLINK™ data collection software include: verifying that the entity identification number is set up in the BEEFLINK™ data collection software program; placing the diskette which was included within the bar coded event/detail listing into the disk drive; running the only file on the disk, thus defining the bar codes listed and recognizing the bar codes by BEEFLINK data collection software. Next, determine whether there is information that is common to all cards by visually examining the data cards and if so enter all cards with the event “Group” and name the group in the “Detail” field. After all of the electronic identification bar codes have been entered along with the group event, perform the “Assign Group Events” within BEEFLINK™ data collection software for the common event. The bar coded event/detail listing 1300 will list the predefined events and details with the corresponding bar code. Rather than typing in events at the computer keyboard, the events may be scanned using the bar coded event/detail listing 1300. The bar coded event/detail listing is designed to assist the livestock producer with information from the data card. The bar coded event/detail listing 1300 features event/detail options, in generally sequential order, as they appear on the data card 140. The remainder of the bar coded event/detail listing 1300 includes a listing of the bar coded events/details that may be required to complete the “other” fields from the data card 140.

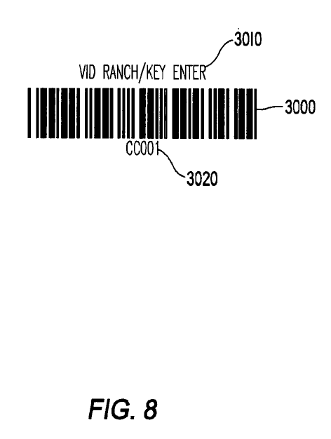

Referring now to FIG. 8, an illustration of a bar code used for entering data, each event/detail code 3000 is comprised of a header 3010 identifying the event and/or detail definition for the bar code below the header. For example, the header 3010 for the bar code used to enter the animal's breed as angus would indicate on the header “Breed/Angus”. A code identifier 3020 appears under the bar code. When a bar code cannot be read by the scanner, the code identifier may be keyed into BEEFLINK data collection software for the relevant event/detail when the user is prompted. Events with a detail of “KEY ENTER” will require key entry for the detail information. Blank bar codes, or codes without a header are allocated for the user to define the events/details that are frequently used but not defined in the bar code listing. The code identifier is the same as “TXP”. Data entry time will be reduced by scanning events and details as opposed to key entry.

Now that BEEFLINK™ data collection software has been set up, the user is prepared to enter the data card information. The user enters the “Work Cattle—Start” section of BEEFLINK™ data collection software. The user then turns “Office Defaults” to “Off”. The user is then prompted to “Scan TXP”.

Referring back to FIG. 7, the animal identification bar code 125 is scanned from the data card 140. The user is then prompted to “re-scan”. The animal identification bar code is then re-scanned from the data card. The user may then begin to scan the bar codes from the bar coded event/detail listing 1300 that correspond to the completed information on the data card 140. The user will then be prompted to key enter detail information. The user should then key enter detail information when prompted. Where “brand”, “method” and “dose” are specified for vaccinations and medications, the user should enter the corresponding information together. For example, the codes for the BRSV vaccination should be scanned corresponding to the following headers in sequential order as follows:

VACCINATE/BRSV
DRUG MFG/KEY ENTER (enter manufacturer name)
METHOD/** (**represents the method detail specified)
DOSE/** (**represents the dosage specified)

Once the information is completed for a single data card, the user can proceed to the data card for the next animal by scanning the animal identification bar code for the new data card. Once all the cards for a group have been entered, the Group Events for that group of cards should be entered. The user should then return to the BEEFLINK™ data collection software Command Center. The user may send the information to others by applying Pony Express Relay Database™ to the information processed. Pony Express Relay Database is available commercially from AgInfoLink Global, Inc. Because of the bar code scanner interface, user definable events and details will be slightly more cumbersome. For ease and efficiency, labels can be made for frequently used events and details that do not appear in the bar coded event/detail listing. The label can be applied to blank pages at the end of the bar coded event/detail listing.

The sales certification form is verified and archived. As previously noted, preferably, the first electronic database is maintained on a host computer running a first software application such as BEEFLINK™ data collection software, produced by AgInfoLink, Inc., Longmont, Colo. All required vaccines, treatments, nutrition, and other processes are listed on the card so that the seller may document that those events have happened on an individual animal basis.

In the first electronic database, each animal is given its own unique number according to its unique animal code and a historical record with all vaccinations, treatments, and nutrition is created. Before the sales even begins, there is an individual record of each animal in the first electronic database.

Auction Check-In

The day before the sale, the seller loads the animals into a trailer/truck and brings them to the sales barn facility. Referring back to FIG. 6, auction barn employees generally take a head count, and verify that the animal has been equipped with an electronic identification unit at step 2150. The auction barn then receives the animal into the auction barn facility at step 2160. An auction barn employee then gives the seller a receipt for each animal as in step 2170. Some states also require that a state form be completed with a description of the animal. Animals are unloaded from the truck and are put into a pen.

Feedyards generally purchase animals at auction. The feedyards will attempt to place uniform groups of cattle together so they eat about the same, gain about the same amount of weight, and will be ready to ship to the packing plant about the same time. For example, if a feedlot places a four hundred (400) pound calf in a pen with an eight hundred (800) pound calf, the larger animal will eat more of the feed and typically the smaller animal will not gain weight adequately. The feedlot's compensation will be reduced at the packing plant if an animal comes to the packing plant too fat, too thin, or with bruises. Therefore, the feedlot prefers to keep animals that have the best chance of performing uniformly together. With this concept in mind, after animals are unloaded from the truck and placed in a pen, the animals are taken from the one pen later in the day and are sorted into separate pens based upon their size, type/frame, and breed as in step 2180. An animal's “frame” is similar to an animal's build. Just as some humans are thin and lean, while others are heavy and stocky, and still others are average, animals also come with different builds. Animals which are of similar frames tend to perform better together.

After the animals are sorted by size, type/frame, and breed, the animals are moved through an alley, through the sale ring, and onto a scale. Once on the scale, the animal's electronic identification unit is scanned with an RFID reader unit and the unique animal code contained in the electronic identification unit is uploaded to a host computer by wireless radio frequency connection as in step 2190. Preferably, the RFID reader is one called TAGTRACKER, produced by AgInfoLink, Inc., Longmont, Colo. When the animal's tag is scanned, its unique animal code is recorded in the host computer. The animal's weight from the scale is also recorded as in step 2200. Preferably, the unique animal code and weight are recorded using a second software application into a second electronic database. Preferably, the software is an existing piece of auction market software called SORTIT™ software developed by General Computing Systems in Edmonton, Canada. The reader operator uses a number of radio frequency identification transponders, including a radio frequency identification transponder containing a unique group code. The operator reads the appropriate transponder, and assigns that individual animal to the correct group as in step 2210. The information from the reader is uploaded to a host computer by means of wireless radio frequency connection. The unique group code is entered into the second electronic database using the second software application corresponding to the unique animal code.

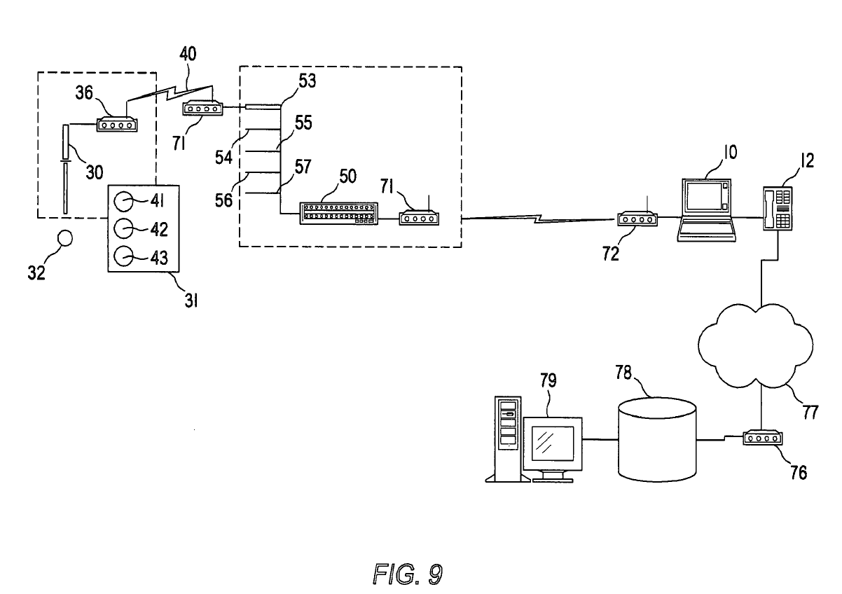

Referring now to FIG. 9, the preferred embodiment for the system for checking the animal in to the auction, such that its weight and unique animal code are recorded, is indicated. The components of the check-in system in the preferred embodiment include a unique Radio Frequency Identification (RFID) transponders for each animal; a corrugated plastic board for the operator to scan, the board containing several group names to assign that individual animal to the correct group; an RFID Reader that can identify the animal and group assignment RFID transponders; a wireless RFDC communication between the reader and a data consolidator unit which has multiple ports for livestock measurement data; a multi-ported data concentrator unit for connection to a scale, a thermometer, an ultrasound measurement device, and an output device, a wireless RFDC communication between the data concentrator unit and the host computer; BeefLink™ Data Collection Software; SORTIT™ auction market software; and database protocol converter communication and integration tools.

Radio Frequency Identification (RFID) Transponders

Although the data collection system can operate manually with visual animal identification, the preferred operation is with Radio Frequency Identification (RFID) transponders 32 in the form of electronic ear tags, implants, boli or neck or leg collars to provide unique identification for each animal. Although ear tags and implants are the most common devices, a bolus transponder has been used successfully as a tamper-proof means of identification of cattle. The bolus transponder has the potential capability of measuring temperature and pH within the animal. The RFID transponders contain a small antenna attached to an integrated circuit that stores a unique identification number. Unlike bar codes, RFID transponders do not require line-of-sight to be read, the transponder simply needs to come into the proximity of an RFID reader.

RFID Reader

The RFID reader 30 will typically be a stationary reader at high volume at the packer or feedlot operations and portable readers at other processing points. Stationary readers will be typically be connected to a host computer or data consolidator be means of a cable, but a wireless connection may also be used for stationary readers. The portable readers will typically use a wireless connection to the computer. The readers emit a low radio frequency signal that excites the passive transponder in the event or animal identification tag. Once excited, the transponder responds back to the reader via radio frequency with a digital signal representing its unique identification code. The reader decodes the signal, displays the identification, and sends the identification to the computer.

Work Card and Group Assignment RFID Tags

A corrugated plastic board 31 with RFID transponders 41, 42 and 43 provides group assignment identification so that group assignments can be read by the RFID reader rather than entered by keyboard. The tags on the corrugated plastic board have a name or symbol label for the corresponding group so that the person working the cattle can quickly scan the appropriate event when it occurs.

Data Concentrator

A hardware device called a Data Concentrator 50 is used as a hub to receive inputs from multiple peripherals and to send the data to the processing computer 10. Although the connection between the data concentrator and the computer may be cabled in some high volume applications, the preferred embodiment is radio frequency wireless data communication. One communication port on the data concentrator will typically be dedicated to the RFDC transmitter/receiver, and the host computer will be ported to a transmitter/receiver. Serial data can be both transmitted and received between the computer and the concentrator using standard direct-connect serial cables or via radio frequency data communication (RFDC). The Data Concentrator accepts a signal from the reader through RFDC transmitter/receivers 36 and 71, typically from a serial port 53, and may also accept data from other measurement devices or provide data to output devices through other available ports 54, 55, 56, and 57. These devices can include electronic weigh scales for weighing animals, digital thermometers to determine if an animal has a fever, bar code scanners to scan drug containers, and ultrasound equipment to measure back fat and detect pregnancy. Other peripherals include output devices that notify the user of the results of an input such as a light, an audible signal to signify that the input has reached the computer, an LED display, or an electronic voice response. The preferred model of the data concentrator is Western Telemetric Model STC61, which is a 6 serial port unit.

The Data Concentrator is linked to a host computer 10 through transmitter/receivers 36 and 71, by wireless radio frequency connection between radio frequency transmitter/receivers 71 and 72. The computer receives, processes, and stores the RFID scans and other data and generates a feedback confirmation signal back to the Data Concentrator. The preferred computer is an IBM™-compatible desktop or laptop computer with a Windows™ 95 operating system.

BEEFLINK™ Data Collection Software and SORTIT™ Software

The SORTIT™ software running on the computer 10 receives inputs from the various devices (including the RFID reader and the scale), notifies the user of the data received, stores the results, and converts the data into meaningful information. In addition, the BEEFLINK™ data collection software manages the transfer of the local data via modem to regional and national databases for storage and further analysis, and manages the access to downstream processing, performance, and quality data.

Referring back to FIG. 9, after the animal is checked in to the auction barn, the animals are resorted. The first sort was preliminary and the animals are sorted a second time to confirm that all animals are in the appropriate grouping as in step 2220. During the second sort, the animal is not weighed but the tag and the appropriate grouping are scanned. At the end of sorting, the second software application will cause a listing of all the animals in the sales to be printed. The group assignment and individual animal will appear on this list.

The Auction

The animals are auctioned in step 2230. Animals can be sold as individuals or as a group. Buyers are typically looking for large groups or drafts of cattle. Most cattle buyers are purchasing cattle for feedyards. Similar to hotels, feedyards make money based upon occupancy. Feedyards generally have large pens. The higher the number of cattle which are placed in a pen, the more profitable the feedyard is. The feedyard generally must have feed delivered to the pens and have a feedyard operator monitor the cattle's health. These are static costs if the pen has ten (10) head of cattle or one hundred (140) head of cattle. Large drafts of cattle are simply more economical. Another reason a buyer may want large drafts of cattle is shipping costs. Typically fifty thousand (50,000) pounds of cattle fit on cattle truck. If a buyer has spent the time and money getting a truck to the sale it is advantageous for him to fill up the truck. Thus, a significant number of buyers may prefer to buy animals in large groups.

Generally the whole group which has been sorted according to size, type and breed, will run through the ring at one time at the auction. The animals are sold according to auction protocol. Preferably, the animals are sold as in a live auction. An auctioneer calls out a price, and the price is generally accepted by a potential buyer. The auctioneer then calls out a higher price; that price may be accepted by another potential buyer. The auctioneer continues to call out a higher price until there are no further acceptances. The group of animals is sold at the last accepted price. The auction process is similar for the sale of individual animals.

Buyer data including his or her name and the price of each animal purchased, which may be calculated using the price per pound for the animal and multiplying the price per pound by the weight of the animal, may be manually recorded on paper. The paper may then be transported to the office and an auction barn employee will enter the buyer data into the second electronic database using the second software application as in step 2240. The second software application will cause a seller check to be electronically generated to the seller in step 2250. The second software application will cause a buyer invoice to be electronically generated for the buyer in step 2260.

Post-Auction

The buyer data collected in the second electronic database will be exported from the second electronic database into a nonexecutable, information file in step 2270. The buyer data will be imported into the first electronic database in step 2280. The first electronic database will have a record of each individual animal's life cycle including unique animal code, vaccinations, treatments, nutrition, sale price, and buyer. Most of the data on the individual animal record will be available to the buyer at the time of payment. Information on the animal's origin will not be available. Animal data for the buyer can be provided to the buyer on a floppy disk, but an electronic mail file is preferred. The buyer's electronic mail address may be obtained when the buyer pays for the animals purchased. To obtain the maximum benefit of the system, the buyer would have the first software application, or the BEEFLINK™ data collection software, at their location.

In many cases animals from the auction barn will go to the feedyard. Any events that happen to the animal at the feedyard may be recorded using the BEEFLINK™ Data Collection System at a site where it is installed. Data collected is sent to the BEEFLINK™ database. The BEEFLINK™ databases communicate and share data between each other by means of a communication means, which may include at least one modem and a third software system as in step 2290. This third software system routes the events back to the auction barn where the animal came from. Preferably, the third software system is PONY EXPRESS RELAY DATABASE™ software, produced by AgInfoLink, Inc., Longmont, Colo. Using the third software system, the auction barn employee downloads their electronic mail and sees that new data on cattle has arrived. The auction barn has the unique ability to provide downstream performance data to the primary producer that sold his cattle at the auction barn. The software manages the transfer of the local data via modem to regional and national databases for storage and further analysis, and manages the access to downstream processing, performance, and quality data. This special sale is attracting buyers who utilize the system of the present invention because they are very interested in an animal's history.

Database Architecture and Data Transfer

Data collected at the local level can provide only limited management information to the seller because the seller needs to know the performance results in order to manage accurately for the future. As the data is transferred to a regional or national database, as in 78, it can become more powerful. In many cases, the animals change hands during the production cycle. In order to get results back to the sellers and growers of the livestock, these upstream participants must have the ability to pull information about the animals that the downstream participants enter into the system. Likewise, the downstream participants such as feedlots and packers need to review information on the animals that they are receiving. It is also these large databases that allow for the source verification for food safety issues.

The local software at each participant's facility routinely sends file updates to an alliance or national database using modem transfer through the Internet. With the proper security clearance, users can query the data on their own cattle even after they have been transferred or sold, and this is the information useful for future management decisions. Sellers are also able to purchase reports that benchmark their animals against a compilation of blind data from other sellers. For example, sellers may compare their operations with operations of a similar size, geographic region, or breed for quality characteristics such as the tenderness score.

Once the animal reaches the slaughter plant, the same RFID transponder is used for identification. Stationary readers are used to read the transponders and to identify and sequence the carcasses. Data such as carcass weight, grade, and yield are collected and added to packer's management system, and that data can be accessed through the animal's identification.

Source Verification/Performance Tracking

At any point in the livestock cycle, historical data is available to any entity in the chain of title for the livestock.

At the packing plant, the animal's identification is used to record actual carcass quality data for the animal. The data can include overall evaluation of the carcass as well as information about the amount and quality of particular cuts or products derived from the carcass. This correlation of individual animal identification to actual carcass and product quality data permits the packer to compensate the seller or feedlot according to the actual quality of the product. The seller benefits both by having the potential to receive a greater return for higher quality livestock, and by obtaining information which will permit more informed decisions on herd management. For instance, bulls or cows that produce calves with good yields and quality will be preferred for retention in the herd over bulls or cows that produce calves with lower yields or lower quality.

Whereas the prior art requires transmission of packer information back to the feedlot or to sellers, the present invention permits entities in the chain of ownership to have access to the data associated with an animal. An additional objective of the invention is to provide Source Verification by making historical data for the animal available to the packer. This Source Verification will preferably include certified quality control programs such as HACCP plans.

Although the present invention has been particularly shown and described with reference to a preferred embodiment, it will be understood by those skilled in the art that various changes in form and detail may be made without departing from the spirit and the scope of the invention.

1.-20. (canceled)

21. A computer-implemented method comprising:
receiving, from disparate selling entities, event data certifying that products separately processed by the disparate entities each satisfy requirements associated with source or process verified products;
aggregating the products for sale as a group of certified source or process verified products;
effecting, as the group, the sale of the certified source or process verified products to a purchasing entity;
filtering out the event data that identifies the disparate selling entities; and
transferring the filtered event data to the purchasing entity.

22. The method of claim 21, wherein the products further comprise animals.

23. The method of claim 21, wherein receiving the event data further comprises:
processing sales certification event data identifying the disparate selling entities and further comprising weaning date event data, vaccination and medication event data, nutrition event data, treatment event data, electronic identification event data, and health record event data; and
processing other event data identifying the product and further comprising the vaccination and medication event data, the electronic identification event data, and the treatment event data.

24. The method of claim 23, wherein:
the weaning date event data indicates that the product has been weaned at least forty-five days prior to the sale;
the vaccination and medication event data indicates that the product has satisfied a four-way vaccine requirement, administered according to established guidelines;
the nutrition event data indicates that recommended nutrition guidelines have been met or exceeded;
the treatment event data indicates that the product has been castrated, dehorned, or tipped;
the electronic identification event data indicates that the product has been identified using an RFID transponder or bar code, and
the health record event data proves that the product has been processed according to the established guidelines.

25. The method of claim 21, wherein the requirements associated with source or process verified products are satisfied if predetermined life cycle events of the product are documented to a minimum standard.

26. The method of claim 21, wherein aggregating the products for sale further comprises selecting, as the group, at least some products from each of the disparate selling entities.

27. The method of claim 26, wherein the at least some products from each of the disparate selling entities are selected based on a frame, a size, a weight, or a breed of the products.

28. The method of claim 21, wherein, based upon the sale of unidentified products with a common characteristic being effected, products with the common characteristic are aggregated for sale from each of the disparate entities.

29. The method of claim 21, wherein aggregating the products further comprises generating, for each of the aggregated products, event data relating to the aggregation.

30. The method of claim 21, further comprising transmitting the event data to an external database for storage and further analysis.

31. The method of claim 21, further comprising generating, based on the sale being effected, event data relating to the purchasing entity.

32. The method of claim 21, further comprising:
receiving additional event data from the purchasing entity;
determining which of the disparate selling entities are associated with the additional event data; and
transmitting the additional entity to the determined disparate selling entity.

33. The method of claim 32, further comprising:
receiving event data associated with a transfer of one of the group of products from the purchasing entity to an external entity;
transmitting the event data associated with the transfer, to one of the disparate entities; and
transmitting the filtered event data to the external entity.

34. The method of claim 21, wherein the event data associated with the transfer further comprises amount and quality event data associated with a meat product derived from one of the group of certified source or process verified products.

35. The method of claim 21, further comprising:
generating a compilation of the filtered event data;
receiving comparison event data from a comparing entity; and
benchmarking the comparison event data against the compilation.

36. The method of claim 21, further comprising:
receiving, from one of the disparate selling entities, a request to access the event data after the sale; and
determining, based on a security clearance, whether the one of the disparate selling entities is authorized to access the event data; and
transmitting, if the one of the disparate selling entities is authorized to access the event data, the event data to the one of the disparate selling entities.

37. The method of claim 21, further comprising permitting the purchasing entity to compensate the disparate selling entities based on event data generated after the sale, without identifying the disparate selling entities to the purchasing entity.

38. The method of claim 21, further comprising filtering out the event data that indicates that the selling entities are disparate.

39. A computer program product, tangibly embodied in a machine-readable medium, the computer program product comprising instructions that, when read by a machine, operate to cause data processing apparatus to:
receive, from disparate selling entities, event data certifying that products separately processed by the disparate entities each satisfy requirements associated with source or process verified products;
aggregate the products for sale as a group of certified source or process verified products;
effect, as the group, the sale of the certified source or process verified products to a purchasing entity;
filter out the event data that identifies the disparate selling entities; and
transfer the filtered event data to the purchasing entity.

40. A device comprising:
a communication module configured to:
receive, from disparate selling entities, event data certifying that products separately processed by the disparate entities each satisfy requirements associated with source or process verified products, and
transfer filtered event data to a purchasing entity; and
a processor configured to:
aggregate the products for sale as a group of certified source or process verified products,
effect, as the group, the sale of the certified source or process verified products to the purchasing entity, and
filter out the event data that identifies the disparate selling entities.
